(19) United States
(12) Patent Application Publication
(10) Pub. No.: US 2012/0031088 A1
(43) Pub. Date: Feb. 9, 2012

(54) HYDRAULIC DRIVE SYSTEM FOR CONSTRUCTION MACHINE

(75) Inventors: Yoshifumi Takebayashi, Koka-shi (JP); Yasutaka Tsuruga, Moriyama-shi (JP); Kiwamu Takahashi, Koka-shi (JP); Kazushige Mori, Koka-shi (JP)

(73) Assignee: HITACHI CONSTRUCTION MACHINERY CO., LTD., Tokyo (JP)

(21) Appl. No.: 13/127,333

(22) PCT Filed: Sep. 14, 2010
(86) PCT No.: PCT/JP10/65872

§ 371 Date: May 3, 2011

(30) Foreign Application Priority Data
Nov. 18, 2009 (JP) 2009-263172

(51) Int. Cl. F15B 21/08

(52) U.S. Cl. 60/452

(57) ABSTRACT

A hydraulic drive system for a construction machine allows automatic changes of the operational characteristics of a boom directional control valve by judging whether or not a hydraulic boom cylinder needs driving pressure at the time of a boom lowering operation.

A solenoid switch valve is controlled such that a pilot oil passage with a pressure reducing valve is selected to set the limit of a boom-lowering spool stroke of a boom directional control valve to a middle position L1 when the rod-side pressure of a hydraulic boom cylinder detected by a pressure sensor is less than a threshold value and such that a pilot oil passage is selected to set the limit of the boom-lowering spool stroke of the boom directional control valve to a maximum stroke position L2 when the rod-side pressure is equal to or greater than the threshold value.

### TECHNICAL FIELD

The present invention relates to hydraulic excavators and other construction machines in general and particularly to a hydraulic drive system for a construction machine which allows changes in the operational characteristics of a boom directional control valve.

### BACKGROUND ART

A hydraulic excavator, a construction machine, typically comprises the following components: an undercarriage; an upper swing structure mounted swingably atop the undercarriage; a multi-joint front arm structure including a boom, an arm, and a bucket, the arm structure being attached to the upper swing structure in a vertically movable manner; and multiple hydraulic cylinders designed to actuate the boom, the arm, and the bucket. The hydraulic drive system of the excavator includes the following components: a hydraulic pump; multiple operating devices for controlling the operation (operational direction and speed) of the boom and the like; and multiple directional control valves for controlling the flow (flow direction and flow rate) of pressurized oil routed from the hydraulic pump to a hydraulic boom cylinder and the like in response to the operation of the operating devices. An open-center directional control valve includes a center bypass oil passage(s) and meter-in and meter-out oil passages, and the orifice areas of these oil passages determine the operational characteristics of the directional control valve, thereby also determining the operational performance of components to be actuated.

Thus far, a method has been proposed in which either of first and second boom directional control valves, both being open center valves but differing in operational characteristics, is selected (see Patent Document 1). The hydraulic drive system of Patent Document 1 includes the following components: a hydraulic pilot operating device; a solenoid switch valve placed on the pilot line of the operating device; and a manual switch for controlling the solenoid switch valve. When the operator turns the manual switch off, the solenoid switch valve is placed in a first switch position, allowing the operating device to output a spool-control pilot pressure to a pressure receiver of a first boom directional control valve. When, on the other hand, the operator turns the manual switch on, the solenoid switch valve is placed in a second switch position, allowing the operating device to output a spool-control pilot pressure to a pressure receiver of a second boom directional control valve. This allows selection of the operational performance suitable for the work at hand.

### PRIOR ART DOCUMENT

### Patent Document

Patent Document 1: JP-2005-220544-A

### SUMMARY OF THE INVENTION

### Problem to be Solved by the Invention

By using the technique of Patent Document 1, it would be possible that the orifice area of a center bypass oil passage of the first boom directional control valve is allowed to become larger than that of a meter-in oil passage of the first boom directional control valve when the spool of the first boom directional control valve is in the maximum position of a boom-lowering spool stroke and that the orifice area of a center bypass oil passage of the second boom directional control valve is allowed to become smaller than that of a meter-in oil passage of the second boom directional control valve (or the center bypass oil passage of the second boom directional control valve is allowed to close completely) when the spool of the second boom directional control valve is in the maximum position of a boom-lowering spool stroke. In that case, the operator can be allowed to turn the manual switch off to select the first boom directional control valve while the bucket is in the air without touching the ground at the time of lowering the boom, whereby the amount of oil supplied to the rod side of the hydraulic boom cylinder can be made relatively small. As a result, the own weight of the front arm structure helps to drive the hydraulic boom cylinder, thereby reducing the power required of the hydraulic pump. When, on the other hand, the bucket reaches the ground to start excavation at the time of lowering the boom, the operator can be allowed to turn the manual switch on to select the second boom directional control valve, so that the amount of oil supplied to the rod side of the hydraulic boom cylinder can be made relatively large. As a result, driving pressure (i.e., high hydraulic pressure) is generated on the rod side of the hydraulic boom cylinder, thereby allowing a powerful boom descending motion.

However, excavation requires repetitions of boom ascending and descending motions, forcing the bucket to repeatedly move from the ground into the air and vice versa. Thus, every time the boom is lowered, the operator is required to operate the manual switch right after the bucket has touched the ground (in other words, at the timing when the hydraulic boom cylinder requires driving pressure). This is not only bothersome to the operator but could lead to a decrease in labor efficiency.

An object of the present invention is thus to provide a hydraulic drive system for a construction machine which allows automatic changes in the operational characteristics of a boom directional control valve by judging whether or not a hydraulic boom cylinder needs driving pressure at the time of a boom-lowering operation.

### Means for Solving the Problem

(1) To achieve the above object, the invention provides a hydraulic drive system for a construction machine, the system comprising: a hydraulic pump; a hydraulic boom cylinder for actuating a boom; an operating device for controlling the operation of the boom; and a boom directional control valve for controlling the flow of pressurized oil routed from the hydraulic pump to the hydraulic boom cylinder in response to the operation of the operating device, the boom directional control valve being an open center valve, the system having characteristics that allow the orifice area of a center bypass oil passage of the boom directional control valve to become larger than the orifice area of a meter-in oil passage of the boom directional control valve when a spool of the boom directional control valve is in the middle position of a boom-lowering spool stroke and that allow the orifice area of the center bypass oil passage to become smaller than the orifice area of the meter-in oil passage or allow the center bypass oil passage to completely close when the spool is in the maximum stroke position of the boom-lowering spool stroke. The system further comprises: stroke limit varying means for selecting either the middle position or the maximum stroke position as the limit of a boom-lowering spool stroke of the boom directional control valve; pressure judging means for detecting or receiving an oil-feeding-side pressure of the hydraulic boom cylinder upon lowering the boom and for judging whether or not the oil-feeding-side pressure is equal to or greater than a predetermined threshold value; and control means for controlling the stroke limit varying means such that the limit of the boom-lowering spool stroke of the boom directional control valve is set to the middle position when the oil-feeding-side pressure of the hydraulic boom cylinder upon lowering the boom is less than the threshold value and such that the limit of the boom-lowering spool stroke of the boom directional control valve is set to the maximum stroke position when the oil-feeding-side pressure of the hydraulic boom cylinder upon lowering the boom is equal to or greater than the threshold value.

(2) In the above hydraulic drive system (1), the stroke limit varying means preferably includes: a first pilot oil passage for outputting a spool-control pilot pressure generated based on a boom-lowering operation by the operating device to a pressure receiver of the boom directional control valve without any change to the spool-control pilot pressure; a second pilot oil passage for reducing, with the use of a pressure-reducing valve, a spool-control pilot pressure generated based on a boom-lowering operation by the operating device and then outputting the reduced pressure to the pressure receiver of the boom directional control valve; and pilot-oil-passage selecting means for selecting either the first pilot oil passage or the second pilot oil passage. Preferably, the control means controls the pilot-oil-passage selecting means such that the second pilot oil passage is selected when the oil-feeding-side pressure of the hydraulic boom cylinder upon lowering the boom is less than the threshold value and such that the first pilot oil passage is selected when the oil-feeding-side pressure of the hydraulic boom cylinder upon lowering the boom is equal to or greater than the threshold value.

(3) In the above hydraulic drive system (1), the stroke limit varying means preferably includes: a pilot oil passage for outputting a spool-control pilot pressure generated based on a boom-lowering operation by the operating device to a pressure receiver of the boom directional control valve; and a variable pressure-reducing valve, located on the pilot oil passage, for limiting the maximum value of the spool-control pilot pressure in a variable manner. Preferably, the control means controls a limit value set for the variable pressure-reducing valve such that the limit value becomes a predetermined first limit value when the oil-feeding-side pressure of the hydraulic boom cylinder upon lowering the boom is less than the threshold value and such that the limit value becomes a predetermined second limit value larger than the first limit value when the oil-feeding-side pressure of the hydraulic boom cylinder upon lowering the boom is equal to or greater than the threshold value.

(4) To achieve the above object, the invention also provides a hydraulic drive system for a construction machine, the system comprising: a hydraulic pump; a hydraulic boom cylinder for actuating a boom; an operating device for controlling the operation of the boom; and a first boom directional control valve for controlling the flow of pressurized oil routed from the hydraulic pump to the hydraulic boom cylinder in response to the operation of the operating device, the first boom directional control valve being an open center valve, the system having characteristics that allow the orifice area of a center bypass oil passage of the first boom directional control valve to become larger than the orifice area of a meter-in oil passage of the first boom directional control valve when a spool of the first boom directional control valve is in the middle position of a boom-lowering spool stroke and that allow the orifice area of the center bypass oil passage to become smaller than the orifice area of the meter-in oil passage or allow the center bypass oil passage to completely close when the spool is in the maximum stroke position of the boom-lowering spool stroke. The system further comprises: a second boom directional control valve, the second boom directional control valve being an open center valve, the orifice area of a center bypass oil passage of the second boom directional control valve being larger than the orifice area of a meter-in oil passage of the second boom directional control valve when a spool of the second boom directional control valve is in the middle position and the maximum stroke position of a boom-lowering spool stroke; directional-control-valve selecting means for selecting either the first boom directional control valve or the second boom directional control valve and actuating the selected boom directional control valve in response to the operation of the operating device; pressure judging means for detecting or receiving an oil-feeding-side pressure of the hydraulic boom cylinder upon lowering the boom and for judging whether or not the oil-feeding-side pressure is equal to or greater than a predetermined threshold value; and control means for controlling the directional-control-valve selecting means such that the second boom directional control valve is selected when the oil-feeding-side pressure of the hydraulic boom cylinder upon lowering the boom is less than the threshold value and such that the first boom directional control valve is selected when the oil-feeding-side pressure of the hydraulic boom cylinder upon lowering the boom is equal to or greater than the threshold value.

(5) In the above hydraulic drive system (4), the directional-control-valve selecting means preferably includes: a first pilot oil passage for outputting a spool-control pilot pressure generated based on a boom-lowering operation by the operating device to a pressure receiver of the first boom directional control valve; a second pilot oil passage for outputting a spool-control pilot pressure generated based on a boom-lowering operation by the operating device to a pressure receiver of the second boom directional control valve; and pilot-oil-passage selecting means for selecting either the first pilot oil passage or the second pilot oil passage. Preferably, the control means controls the pilot-oil-passage selecting means such that the second pilot oil passage is selected when the oil-feeding-side pressure of the hydraulic boom cylinder upon lowering the boom is less than the threshold value and such that the first pilot oil passage is selected when the oil-feeding-side pressure of the hydraulic boom cylinder upon lowering the boom is equal to or greater than the threshold value.

### Effect of the Invention

In accordance with the invention, it is possible to automatically change the operational characteristics of a boom directional control valve by judging whether or not a hydraulic boom cylinder needs driving pressure at the time of a boom-lowering operation.

### BRIEF DESCRIPTION OF THE DRAWINGS

FIG. 1 is a side view of a small-sized hydraulic excavator to which the present invention is applied;

FIG. 2 is a hydraulic circuit diagram illustrating essential components of a hydraulic drive system for a hydraulic excavator according to Embodiment 1 of the invention;

FIG. 3 is a graph illustrating the operational characteristics of a boom directional control valve according to Embodiment 1 of the invention;

FIG. 4 is a graph related to Embodiment 1, illustrating an example of temporal changes in the rod-side pressure of a hydraulic boom cylinder and in the spool-control pilot pressure input to the boom directional control valve;

FIG. 5 is a hydraulic circuit diagram illustrating essential components of a hydraulic drive system for a hydraulic excavator according to a modification of the invention;

FIG. 6 is a hydraulic circuit diagram illustrating essential components of a hydraulic drive system for a hydraulic excavator according to Embodiment 2 of the invention;

FIG. 7 is a hydraulic circuit diagram illustrating essential components of a hydraulic drive system for a hydraulic excavator according to a modification of the invention;

FIG. 8 is a hydraulic circuit diagram illustrating essential components of a hydraulic drive system for a hydraulic excavator according to Embodiment 3 of the invention; and

FIG. 9 is a graph illustrating the operational characteristics of a second boom directional control valve according to Embodiment 3 of the invention.

### MODE FOR CARRYING OUT THE INVENTION

Embodiments of the present invention will now be described with reference to the accompanying drawings.

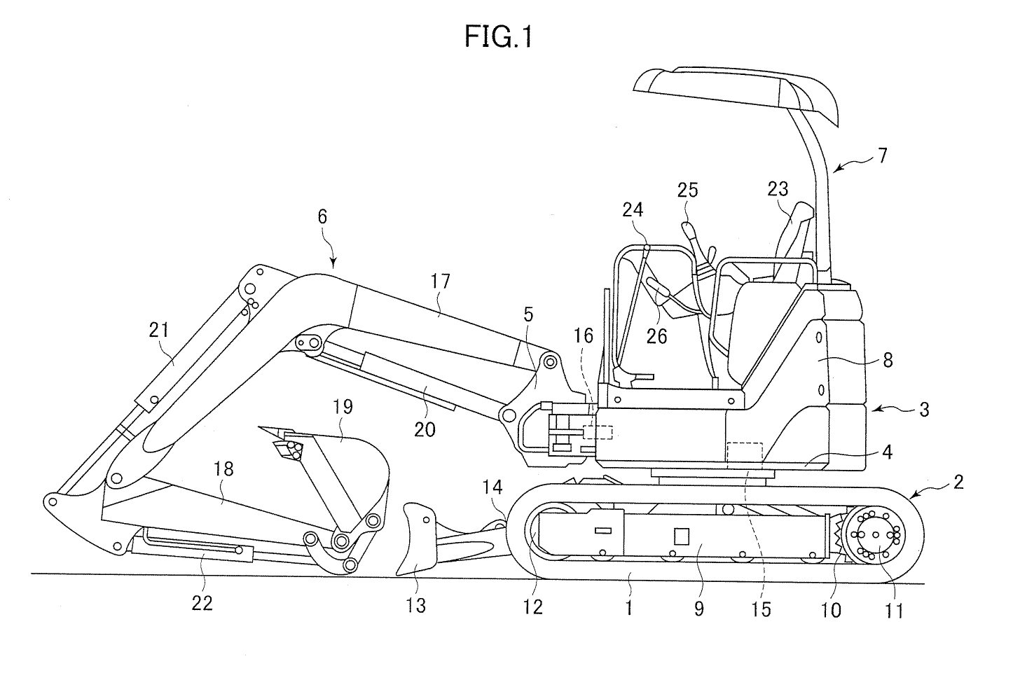

FIG. 1 is a side view of a small-sized hydraulic excavator to which the present invention is applied. Note that the front side, the rear side, the left side, and the right side as viewed from an operator seated on the cab seat of the hydraulic excavator are hereinafter referred to simply as the front side (the left side of FIG. 1), the rear side (the right side of FIG. 1), the left side (the front side of FIG. 1), and the right side (the back side of FIG. 1), respectively.

The hydraulic excavator of FIG. 1 comprises the following components: an undercarriage 2 with right and left trackbelts 1 (crawlers); an upper swing structure 3 mounted swingably atop the undercarriage 2; a swing frame 4 that servers as a base structure for the upper swing structure 3; a swing post 5 attached to the front of the swing frame 4 in a horizontally movable manner; a multi-joint front arm structure 6 attached to the swing post 5 in a vertically movable manner; a canopy-attached cab 7 located on the left side of the swing frame 4; and multiple covers 8 for covering most of the swing frame 4 except the cab 7. Installed inside the covers 8 of the upper swing structure 3 are devices such as an engine and the like.

The undercarriage 2 includes the following components: a substantially H-shaped track frame 9; right and left drive wheels 10 attached rotatably to the right and left rear sides of the track frame 9; right and left hydraulic travel motors 11 for driving the right and left drive wheels 10, respectively; and right and left follower wheels 12 (idler wheels) attached rotatably to the right and left front sides of the track frame 9 and driven by the drive force transmitted from the drive wheels 10 via the trackbelts 1.

Attached to the front side of the track frame 9 is a soil-removal blade 13 which is vertically moved by a hydraulic blade cylinder 14. Between a central portion of the track frame 9 and the swing frame 4 is a rotary wheel, not illustrated. Radially inside this rotary wheel is a hydraulic swing motor 15 which is designed to rotate the swing frame 4 relative to the track frame 9.

The horizontal movement of the swing post 5 relative to the swing frame 4 is achieved by a vertical pin, not illustrated, and by a hydraulic swing cylinder 16. The horizontal movement of the swing post 5 causes the front arm structure 6 to swing rightward or leftward.

The front arm structure 6 includes the following components: a boom 17 attached movably to the swing post 5; an arm 18 attached movably to the distal end of the boom 17; and a bucket 19 attached movably to the distal end of the arm 18. The boom 17, the arm 18, and the bucket 19 are actuated by a hydraulic boom cylinder 20, a hydraulic arm cylinder 21, and a hydraulic bucket cylinder 22, respectively. Note that the bucket 19 can be replaced by an optional attachment (e.g., a crusher).

The cab 7 is provided with a cab seat 23 on which the operator is seated. Located in front of the seat 23 are right and left travel levers 24 which are operable with hands or feet and designed to actuate the right and left hydraulic travel motors 11, respectively, so as to move the hydraulic excavator forward or backward. Located to the left of the left travel lever 24 (at the bottom left section of the cab 7) is an attachment control pedal, not illustrated, for controlling a hydraulic attachment actuator. Located to the right of the right travel lever 24 (at the bottom right section of the cab 7) is a swing control pedal, not illustrated, for actuating the hydraulic swing cylinder 16 to swing rightward or leftward the swing post 5 (that is, the entire front arm structure 6).

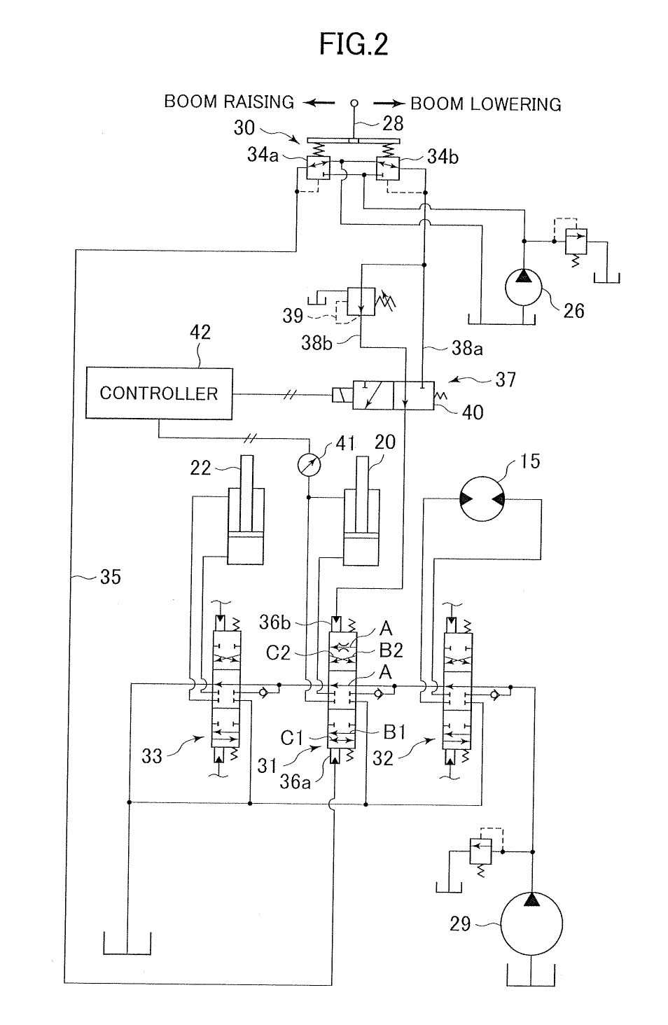

Located on the left side of the seat 23 are the following components: a crosswise-movable swing/arm control lever 25 for actuating the hydraulic swing motor 15 to swing the upper swing structure 3 right or left when the lever 25 is moved right or left and for actuating the hydraulic arm cylinder 21 to cause the arm 18 to perform a dump or crowd operation when the lever 25 is moved forward or backward; and a lock lever 27, provided as an anti-false operation lever, for blocking the supply of source pressure from a pilot pump 26 (see FIG. 2). Located on the right side of the seat 23 are the following components: a crosswise-movable bucket/boom control lever 28 (see FIG. 2) for actuating the hydraulic bucket cylinder 22 to crowd or dump the bucket 19 when the lever 28 is moved left or right and for actuating the hydraulic boom cylinder 20 to lower or raise the boom 17 when the lever 28 is moved forward or backward; and a blade control lever, not illustrated, for actuating the hydraulic blade cylinder 14 to raise or lower the blade 13.

The above-mentioned right and left trackbelts 1, upper swing structure 3, swing post 5, blade 13, boom 17, arm 18, and bucket 19 are those components driven by a hydraulic drive system installed in the hydraulic excavator.

FIG. 2 is a hydraulic circuit diagram of a hydraulic drive system according to Embodiment 1 of the invention, particularly illustrating essential components related to the operation of the boom 17.

The hydraulic drive system of FIG. 2 includes the following components: a hydraulic pump 29 and the pilot pump 26 both driven by the engine (not illustrated); a hydraulic pilot operating device 30 with the lever 28 used for controlling the operation (operational direction and speed) of the boom 17 when the lever 28 is moved forward or backward and for controlling the operation of the bucket 19 when the lever 28 is moved right or left; and a boom directional control valve 31 (open center valve) for controlling the flow (direction and flow rate) of the pressurized oil routed from the hydraulic pump 29 to the hydraulic boom cylinder 20 in response to the forward or backward movement of the lever 28. The hydraulic drive system further includes a swing directional control valve 32 (open center valve) for controlling the flow of the pressurized oil routed from the hydraulic pump 29 to the hydraulic swing motor 15 in response to the rightward or leftward movement of the lever 25; and a bucket directional control valve 33 (open center valve) for controlling the flow of the pressurized oil routed from the hydraulic pump 29 to the hydraulic bucket cylinder 22 in response to the rightward or leftward movement of the lever 28. The three directional control valves, or the swing directional control valve 32, the boom directional control valve 31, and the bucket directional control valve 33, are connected in series in this order.

The operating device 30 includes a pair of pressure reducing valves 34a and 34b for generating a spool-control pilot pressure (a second pilot pressure) by reducing a first pilot pressure supplied from the pilot pump 26 based on how much forward or backward the lever 28 has been moved. When the lever 28 is moved backward (toward the left side of FIG. 2), the pressure reducing valve 34a generates a spool-control pilot pressure based on how much the lever 28 has been moved and then outputs the pressure to a pressure receiver 36a of the boom directional control valve 31 through a pilot line 35. This allows the spool of the boom directional control valve 31 to move from its neutral position to the lower side of FIG. 2 (i.e., in the boom-raising direction) in proportion to how much the lever 28 has been moved. In contrast, when the lever 28 is moved forward (toward the right side of FIG. 2), the pressure reducing valve 34b generates a spool-control pilot pressure based on how much the lever 28 has been moved and then outputs the pressure to a pressure receiver 36b of the boom directional control valve 31 through a pilot circuit 37 (described later). This allows the spool of the boom directional control valve 31 to move from its neutral position to the upper side of FIG. 2 (i.e., in the boom-lowering direction) in proportion to how much the lever 28 has been moved.

The boom directional control valve 31 includes the following components: a center bypass oil passage A; meter-in oil passages B1 and B2 (oil-feeding passages); and meter-out oil passages C1 and C2 (oil-return passages). These oil passages A, B1, B2, C1, and C2 can change their orifice areas based on the stroke amount of the spool of the boom directional control valve 31. When the spool is in its neutral position, the center bypass oil passage A opens fully whereas the meter-in oil passages and the meter-out oil passages close completely. In this case, the pressurized oil supplied from the hydraulic pump 29 is not routed to the hydraulic boom cylinder 20 but returned to a tank. When the spool moves in the boom-raising direction, the meter-in oil passage B1, designed to supply the pressurized oil from the hydraulic pump 29 to the bottom side of the hydraulic boom cylinder 20, and the meter-out oil passage C1, designed to return the oil from the rod side of the hydraulic boom cylinder 20 to the tank, increase in orifice area in response to the stroke amount of the spool. At the same time, the center bypass oil passage A decreases in orifice area; it closes completely at the maximum stroke position. This allows oil the amount of which is proportional to the stroke amount to be supplied to the bottom side of the hydraulic boom cylinder 20, causing the hydraulic boom cylinder 20 to expand. As a result, the boom 17 is raised.

In contrast, when the spool moves in the boom-lowering direction, the meter-in oil passage B2, designed to supply the pressurized oil from the hydraulic pump 29 to the rod side of the hydraulic boom cylinder 20, and the meter-out oil passage C2, designed to return the oil from the bottom side of the hydraulic boom cylinder 20 to the tank, increase in orifice area in response to the stroke amount of the spool. At the same time, the center bypass oil passage A decreases in orifice area. This allows oil the amount of which is proportional to the stroke amount to be supplied to the rod side of the hydraulic boom cylinder 20, causing the hydraulic boom cylinder 20 to contract. As a result, the boom 17 is lowered. Note that Embodiment 1 is designed not to completely close the center bypass oil passage A when the spool is placed in the maximum stroke position in the boom-lowering direction but allows it to partially open. This prevents the descending motion of the boom 17 from becoming much faster than the ascending motion of the boom 17 due to the area difference between the rod side and bottom side of the hydraulic boom cylinder 20.

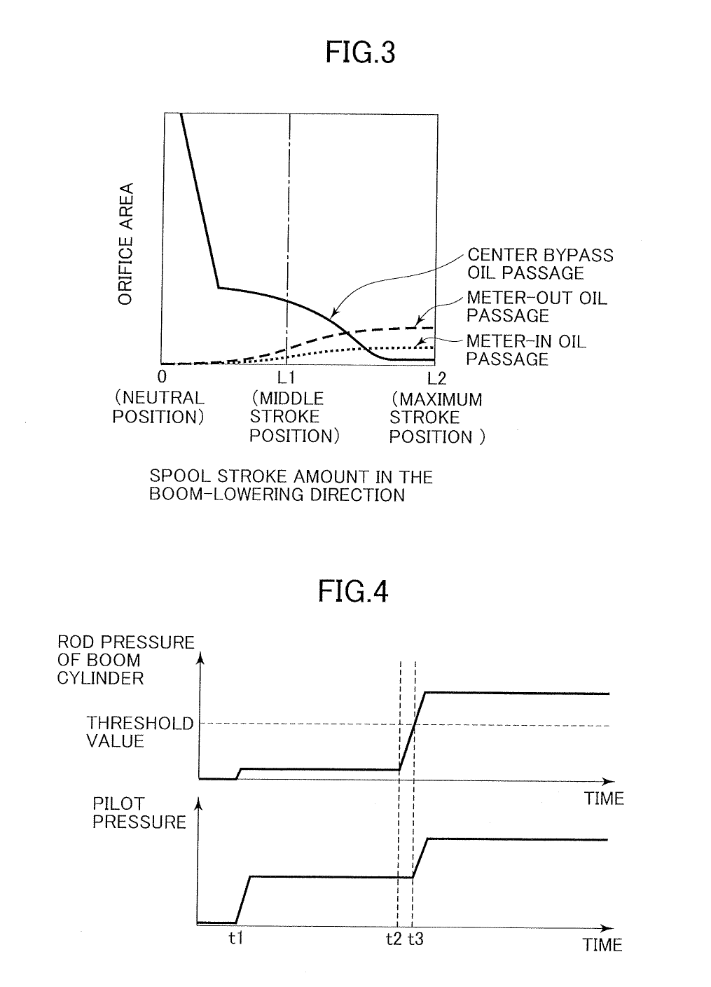

FIG. 3 illustrates the relationship between the spool stroke amount of the boom directional control valve 31 in the boom-lowering direction and the orifice areas of the center bypass oil passage A, the meter-in oil passage B2, and the meter-out oil passage C2. In the figure, the horizontal axis represents the stroke amount of the spool in the boom-lowering direction while the vertical axis represents the orifice areas of the center bypass oil passage A, the meter-in oil passage B2, and the meter-out oil passage C2.

As illustrated in FIG. 3, when the spool is in the middle position L1 of the boom-lowering stroke, the orifice area of the center bypass oil passage A is approximately ten times as large as that of the meter-in oil passage B2. Thus, the meter-in oil passage B2 is relatively small in flow rate (i.e., the flow rate of oil supplied to the rod side of the hydraulic boom cylinder 20 is small). In contrast, when the spool is in the maximum stroke position L2 of the boom-lowering stroke, the orifice area of the center bypass oil passage A is approximately one fifth as large as that of the meter-in oil passage B2. Thus, the flow rate of the meter-in oil passage B2 is relatively large.

With reference again to FIG. 2, the pilot circuit 37 includes the following components: a pilot oil passage 38a for routing the spool-control pilot pressure generated by the pressure reducing valve 34b of the operating device 30 to the pressure receiver 36b of the boom directional control valve 31 without any change to the pressure; a pilot oil passage 38b for reducing, with the use of a pressure reducing valve 39, the spool-control pilot pressure generated by the pressure reducing valve 34b of the operating device 30 and then routing the reduced pressure to the pressure receiver 36b of the boom directional control valve 31; and a solenoid switch valve 40 for selecting either of the pilot oil passages 38a and 38b.

The hydraulic drive system of FIG. 2 further includes a pressure sensor 41 and a controller 42. The pressure sensor 41 detects the rod-side pressure of the hydraulic boom cylinder 20 (i.e., the oil-feeding-side pressure at the time of lowering the boom 17). The controller 42 receives a pressure signal from the pressure sensor 41 to control the operation of the solenoid switch valve 40 based on that signal. Specifically, the controller 42 examines whether or not the rod-side pressure of the hydraulic boom cylinder 20 detected by the pressure sensor 41 is equal to or greater than a predetermined threshold value, thereby judging whether or not the hydraulic boom cylinder 20 needs driving pressure (the rod-side high hydraulic pressure) upon lowering the boom 17. The threshold value is slightly lower than the rod-side load pressure resulting from the start of excavation or the like.

When the rod-side pressure is less than the threshold value (i.e., when driving pressure is not necessary), the controller 42 does not output a drive signal to the solenoid of the solenoid switch valve 40, placing the solenoid switch valve 40 in the right-side switch position of FIG. 2. This allows the spool-control pilot pressure generated by the pressure reducing valve 34b of the operating device 30 to be routed through the pilot oil passage 38b (i.e., through the pressure reducing valve 39) to the pressure receiver 36b of the boom directional control valve 31. As a result, the limit of the boom-lowering spool stroke of the boom directional control valve 31 (i.e., the maximum spool stroke position available when moving the lever 28 furthest forward) is set to the middle position L1 of FIG. 3.

When, on the other hand, the rod-side pressure is equal to or greater than the threshold value (i.e., when driving pressure is necessary), the controller 42 outputs the drive signal to the solenoid of the solenoid switch valve 40, placing the solenoid switch valve 40 in the left-side switch position of FIG. 2. This allows the spool-control pilot pressure generated by the pressure reducing valve 34b of the operating device 30 to be routed through the pilot oil passage 38a (i.e., not through the pressure reducing valve 39) to the pressure receiver 36b of the boom directional control valve 31. As a result, the limit of the boom-lowering spool stroke of the boom directional control valve 31 is set to the maximum stroke position L2 of FIG. 3.

The operation of the hydraulic drive system of Embodiment 1 will now be described with reference to FIG. 4. FIG. 4 is a graph illustrating an example of temporal changes in the rod-side pressure of the hydraulic boom cylinder 20 and in the spool-control pilot pressure input to the pressure receiver 36b of the boom directional control valve 31.

After the operator moves the lever 28 furthest forward (at time t1) to lower the boom 14 for excavation or the like, the solenoid switch valve 40 selects the pilot oil passage 38b because the rod-side pressure of the hydraulic boom cylinder 20 stays smaller than the threshold value while the bucket 19 is in the air without touching the ground (from time t1 to time t2). In other words, a limit is placed on the spool-control pilot pressure so that the limit of the boom-lowering spool stroke of the boom direction control valve 31 can be set to the middle position L1. This reduces the amount of oil supplied to the rod side of the hydraulic boom cylinder 20, keeping the rod-side pressure low. As a result, the own weight of the front arm structure 6 helps to drive the hydraulic boom cylinder 20, thereby reducing the power required of the hydraulic pump 29.

After the bucket 19 touches the ground to start excavation or the like (after time t2), the rod-side pressure of the hydraulic boom cylinder 20 starts to increase. When the rod-side pressure of the hydraulic boom cylinder 20 reaches the threshold value, the controller 42 outputs the drive signal, allowing the solenoid switch valve 40 to select the pilot oil passage 38a. In other words, no limit is placed on the spool-control pilot pressure, and the limit of the boom-lowering spool stroke of the boom direction control valve 31 is set to the maximum stroke position L2. This increases the amount of oil supplied to the rod side of the hydraulic boom cylinder 20, increasing the rod-side pressure further. As a result, driving pressure is generated on the rod side of the hydraulic boom cylinder 20, thereby allowing a powerful boom descending motion.

As above, Embodiment 1 of the present invention makes it possible to automatically change the operational characteristics of the boom directional control valve 31 by judging whether or not the hydraulic boom cylinder 20 needs driving pressure at the time of lowering the boom 17. This is not bothersome to the operator and leads to high labor efficiency, compared with when the operator has to do the above with the use of a manual switch as in Patent Document 1.

As stated above, Embodiment 1 is designed such that the judgment of whether or not the hydraulic boom cylinder 20 needs driving pressure at the time of lowering the boom 17 is made through the examination of whether or not the rod-side pressure of the hydraulic boom cylinder 20 is equal to or greater than the predetermined threshold value. On the other hand, the above judgment may instead be made by, for example, examining whether or not the bottom-side pressure of the hydraulic boom cylinder 20 (i.e., the oil-exhaust-side pressure at the time of lowering the boom 17) is less than a predetermined threshold value. This method, however, leaves room for improvement as discussed below. The bottom-side pressure (back pressure) of the hydraulic boom cylinder 20 at the time of lowering the boom 17 increases in proportion to the operational speed of the hydraulic boom cylinder 20 (i.e., the speed of a descending motion of the boom 17). Assume now that an excavation is judged to have started when the bottom-side pressure of the hydraulic boom cylinder 20 has become less than the threshold value, and the controller 42 then changes the switch position of the solenoid switch valve 40 to set the limit of the boom-lowering spool stroke of the boom directional control valve 31 to the maximum stroke position L2 so that a powerful boom descending motion can be achieved. Even so, the bottom-side pressure of the hydraulic boom cylinder 20 will exceed the threshold value when the speed of the descending motion of the boom 17 exceeds a given value during subsequent excavations. Thus, it is likely that the controller 42 may change the switch position of the solenoid switch valve 40 to set the limit of the boom-lowering spool stroke of the boom directional control valve 31 to the middle position L1 even when the hydraulic boom cylinder 20 does need driving pressure. Consequently, a limit is placed on the speed of the descending motion of the boom 17. In contrast, Embodiment 1 is designed such that the judgment of whether or not the hydraulic boom cylinder 20 needs driving pressure at the time of lowering the boom 17 is made through the examination of whether or not the rod-side pressure of the hydraulic boom cylinder 20 is equal to or greater than the threshold value. Thus, there is no need to limit the speed of the descending motion of the boom 17. Accordingly, a powerful boom descending motion can be achieved, irrespective of the operational speed of the boom 17.

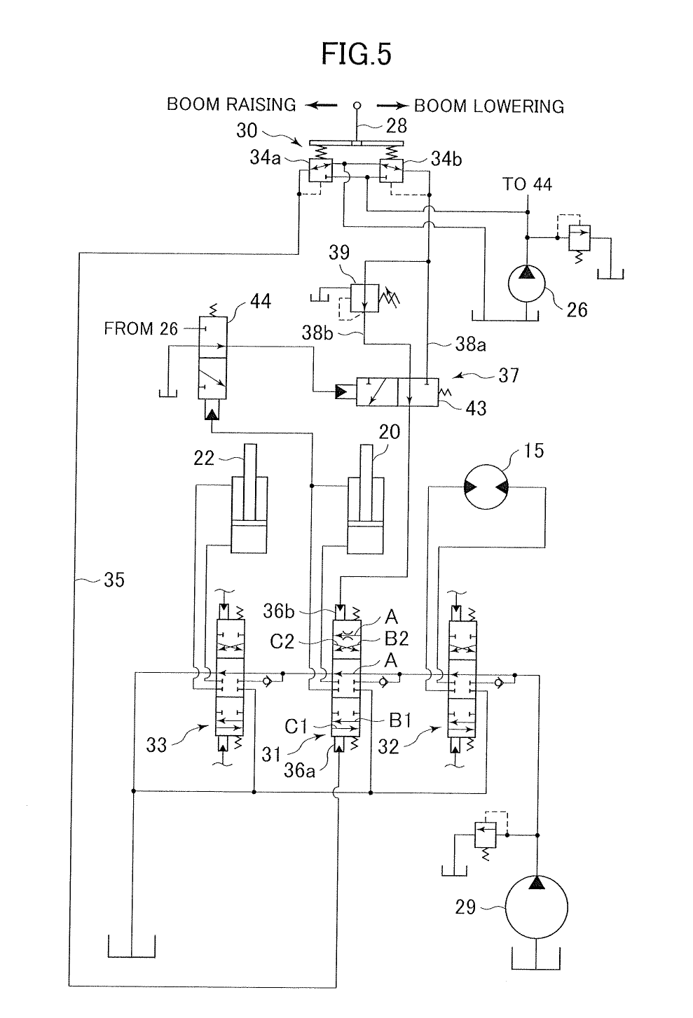

As stated above, the hydraulic drive system of Embodiment 1 includes the solenoid switch valve 40 for selecting either of the pilot oil passages 38a and 38b, the pressure sensor 41 for detecting the rod-side pressure of the hydraulic boom cylinder 20, and the controller 42 for outputting the drive signal to the solenoid of the solenoid switch valve 40 when the rod-side pressure is equal to or greater than the threshold value. Note, however, that the invention is not limited to such an electrical configuration. For instance, as in the modification of FIG. 5, the solenoid switch valve 40 can be replaced by a hydraulic pilot switch valve 43, and the pressure sensor 41 and the controller 42 by a hydraulic pilot control valve 44 for outputting a hydraulic pressure signal to a pressure receiver of the switch valve 43. The control valve 44 includes a pressure receiver for receiving the rod-side pressure of the hydraulic boom cylinder 20 and a spring for setting a threshold value for the rod-side pressure. When the rod-side pressure is less than the threshold value, the control valve 44 is placed in the upper-side switch position of FIG. 5, allowing the pressure receiver of the switch valve 43 to communicate with the tank (that is, the hydraulic pressure received by the pressure receiver of the switch valve 43 becomes the tank pressure, thus becoming smaller). As a result, the switch valve 43 is placed in the right-side switch position of FIG. 5 to select the pilot oil passage 38b. When, on the other hand, the rod-side pressure is equal to or greater than the threshold value, the control valve 43 is placed in the lower-side switch position of FIG. 5, allowing the pressure receiver of the switch valve 43 to communicate with the pilot pump 26 (that is, the hydraulic pressure received by the pressure receiver of the switch valve 43 becomes the pump pressure, thus becoming larger). As a result, the switch valve 43 is placed in the left-side switch position of FIG. 5 to select the pilot oil passage 38a. The above modification also leads to the same advantages of Embodiment 1.

As another modification (not illustrated), it is also possible for the hydraulic drive system not to have the control valve 44 and instead route the rod-side pressure of the hydraulic boom cylinder 20 to a pressure receiver of a switch valve 43A and set a threshold value for the rod-side pressure using the spring of the switch valve 43A. When the rod-side pressure is less than the threshold value, the switch valve 43A is placed in a first switch position (same as the right-side switch position of the switch valve 43 of FIG. 5), thereby selecting the pilot oil passage 38b. When, on the other hand, the rod-side pressure is equal to or greater than the threshold value, the switch valve 43A is placed in a second switch position (same as the left-side switch position of the switch valve 43 of FIG. 5), thereby selecting the pilot oil passage 38a. This modification also leads to the same advantages of Embodiment 1.

As also stated above, the hydraulic drive system of Embodiment 1 includes the pilot oil passages 38a and 38b and the solenoid switch valve 40 for selecting either of the pilot oil passages 38a and 38b as stoke limit varying means for setting the limit of the boom-lowering spool stroke of the boom directional control valve 31 to either of the middle position L1 and the maximum stroke position L2. The invention is of course not limited to this configuration but can be modified in various forms without departing from the technical scope of the invention. For instance, when the invention is applied to a hydraulic excavator which includes an operating device having an electrical lever (i.e., an operating device for outputting an electric control signal based on how much its lever is moved), a controller may be provided in order to either limit or not limit the electrical control signal output from the operating device. This modification as well leads to the same advantages of Embodiment 1.

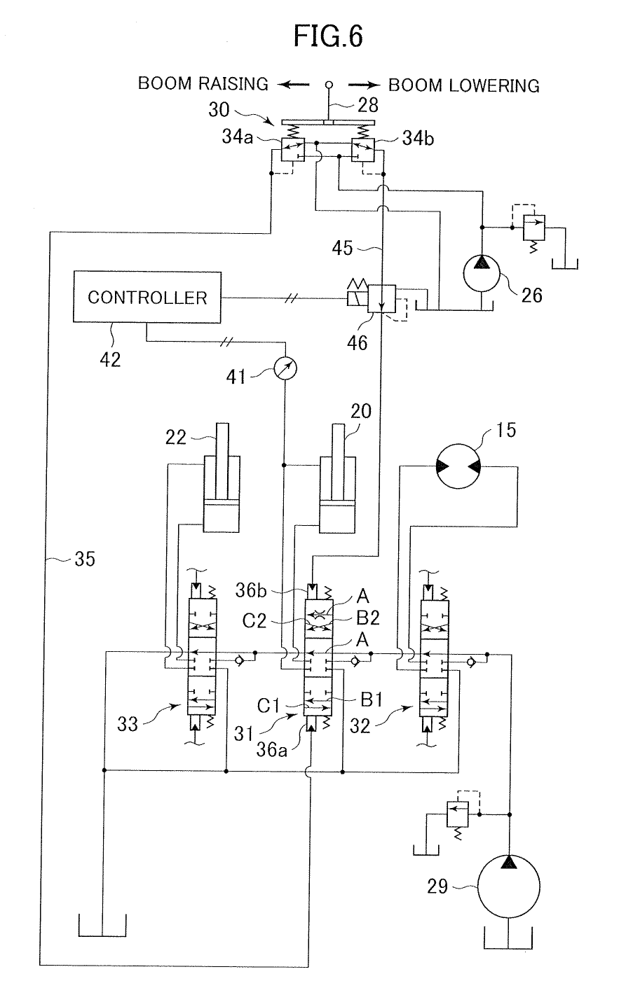

Embodiment 2 of the present invention will now be described with reference to FIG. 6. In this embodiment, the pilot oil passage is provided with a variable pressure-reducing valve. Note that the same reference numerals as used in Embodiment 1 denote identical components, and such components will not be described again.

FIG. 6 is a hydraulic circuit diagram illustrating essential components of a hydraulic drive system according to Embodiment 2.

The hydraulic drive system of Embodiment 2 includes the following components: a pilot oil passage 45 for routing the spool-control pilot pressure generated by the pressure reducing valve 34b of the operating device 30 to the pressure receiver 36b of the boom directional control valve 31; and a solenoid-driven variable pressure-reducing valve 46, placed on the pilot oil passage 45, for limiting the maximum value of the spool-control pilot pressure in a variable manner.

Similar to Embodiment 1, the hydraulic drive system of Embodiment 2 also includes the pressure sensor 41 and the controller 42. The pressure sensor 41 detects the rod-side pressure of the hydraulic boom cylinder 20. The controller 42 examines whether or not the rod-side pressure of the hydraulic boom cylinder 20 detected by the pressure sensor 41 is equal to or greater than the predetermined threshold value, thereby judging whether or not the hydraulic boom cylinder 20 needs driving pressure upon lowering the boom 17. Based on that judgment, the controller 42 controls the variable pressure-reducing valve 46.

When the rod-side pressure is less than the threshold value (i.e., when driving pressure is not necessary), the controller 42 does not output a drive signal to the solenoid of the variable pressure-reducing valve 46. Thus, a limit value for the variable pressure-reducing valve 46 is set to a predetermined first limit value by the spring. This limits the maximum of the spool-control pilot pressure generated by the pressure reducing valve 34b of the operating device 30 to the first limit value. The limited spool-control pilot pressure is then output to the pressure receiver 36 of the boom directional control valve 31. As a result, the limit of the boom-lowering spool stroke of the boom directional control valve 31 is set to the middle position L1 of FIG. 3.

When, on the other hand, the rod-side pressure is equal to or greater than the threshold value (i.e., when driving pressure is necessary), the controller 42 outputs the drive signal to the solenoid of the variable pressure-reducing valve 46, thereby setting the limit value for the variable pressure-reducing valve 46 to a predetermined second limit value which is larger than the first limit value. This limits the maximum of the spool-control pilot pressure generated by the pressure reducing valve 34b of the operating device 30 to the second limit value. The limited spool-control pilot pressure is then output to the pressure receiver 36b of the boom directional control valve 31 (normally, the spool-control pilot pressure generated by the pressure reducing valve 34b of the operating device 30 is output to the pressure receiver 36b without any change to the pressure). As a result, the limit of the boom-lowering spool stroke of the boom directional control valve 31 is set to the maximum stroke position L2 of FIG. 3.

Similar to Embodiment 1, Embodiment 2 of the invention also makes it possible to automatically change the operational characteristics of the boom directional control valve 31 by judging whether or not the hydraulic boom cylinder 20 needs driving pressure at the time of lowering the boom 17. This is not bothersome to the operator and leads to high labor efficiency, compared with when the operator has to do the above with the use of a manual switch as in Patent Document 1.

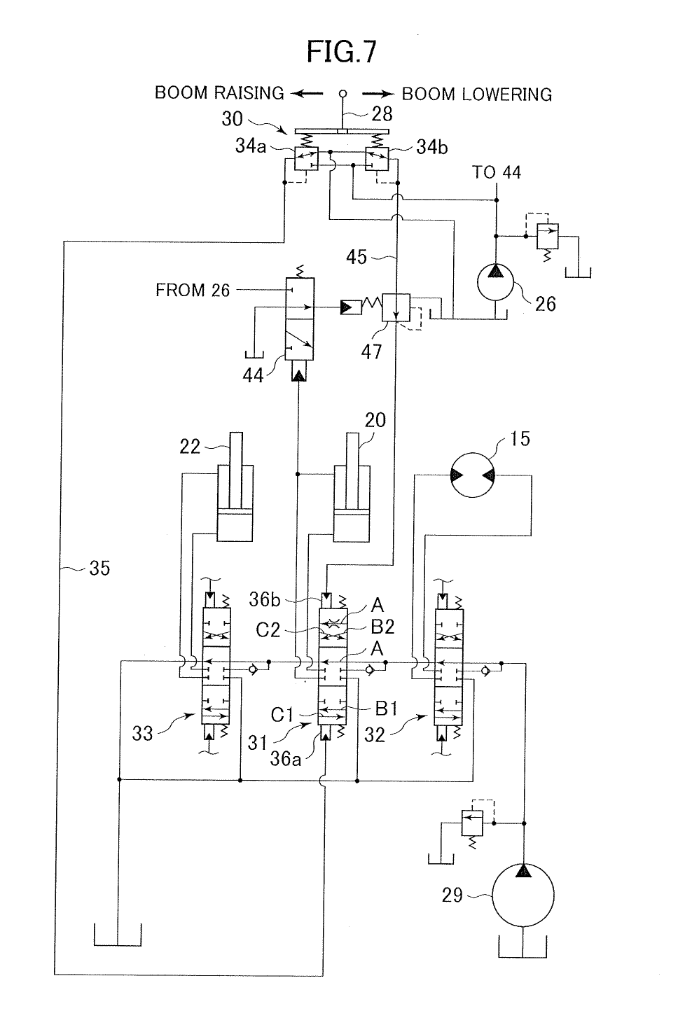

As stated above, the hydraulic drive system of Embodiment 2 includes the solenoid-driven variable pressure-reducing valve 46 placed on the pilot oil passage 45; the pressure sensor 41 for detecting the rod-side pressure of the hydraulic boom cylinder 20; and the controller 42 for outputting the drive signal to the solenoid of the variable pressure-reducing valve 46 when the rod-side pressure is equal to or greater than the threshold value. Note, however, that the invention is not limited to such an electrical configuration. For example, as in the modification of FIG. 7, the solenoid-driven variable pressure-reducing valve 46 can be replaced by a hydraulic pilot variable pressure-reducing valve 47, and the pressure sensor 41 and the controller 42 by a hydraulic pilot control valve 44 for outputting a hydraulic pressure signal to a pressure receiver of the variable pressure-reducing valve 47. The control valve 44 includes a pressure receiver for receiving the rod-side pressure of the hydraulic boom cylinder 20 and a spring for setting a threshold value for the rod-side pressure. When the rod-side pressure is less than the threshold value, the control valve 44 is placed in the upper-side switch position of FIG. 7, allowing the pressure receiver of the variable pressure-reducing valve 47 to communicate with the tank (that is, the hydraulic pressure received by the pressure receiver of the variable pressure-reducing valve 47 becomes the tank pressure, thus becoming smaller). As a result, the variable pressure-reducing valve 47 limits the maximum of the spool-control pilot pressure to the first limit value. When, on the other hand, the rod-side pressure is equal to or greater than the threshold value, the control valve 43 is placed in the lower-side switch position of FIG. 7, allowing the pressure receiver of the variable pressure-reducing valve 47 to communicate with the pilot pump 26 (that is, the hydraulic pressure received by the pressure receiver of the variable pressure-reducing valve 47 becomes the pump pressure, thus becoming larger). As a result, the variable pressure-reducing valve 47 limits the maximum of the spool-control pilot pressure to the second limit value. The above modification also leads to the same advantages of Embodiment 2.

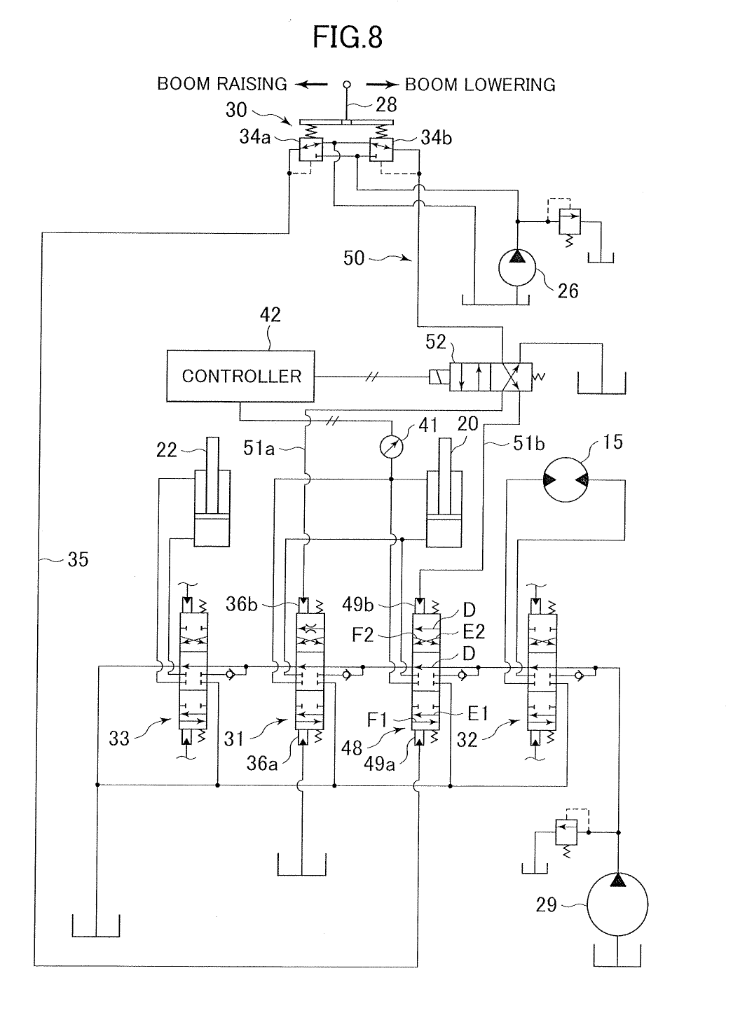

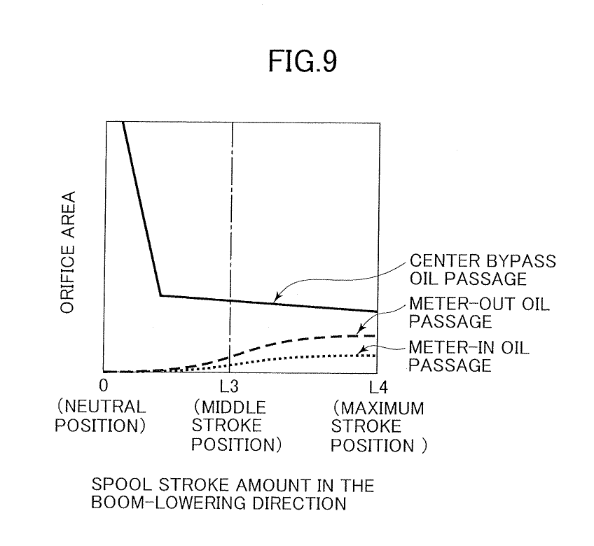

Embodiment 3 of the present invention will now be described with reference to FIGS. 8 and 9. The hydraulic drive system of Embodiment 3 includes first and second boom directional control valves which differ in operational characteristics and is designed to select either of the two directional control valves. Note that the same reference numerals as used in Embodiments 1 and 2 denote identical components, and such components will not be described again.

FIG. 8 is a hydraulic circuit diagram illustrating essential components of the hydraulic drive system of Embodiment 3.

The hydraulic drive system of Embodiment 3 includes the boom directional control valve 31 (open center valve) and a boom directional control valve 48 (open center valve) that differs from the boom directional control valve 31 in operational characteristics. The swing directional control valve 32, the boom directional control valves 31 and 48, and the bucket directional control valve 33 are connected in series in this order.

The boom directional control valve 48 includes the following components: a center bypass oil passage D; meter-in oil passages E1 and E2 (oil-feeding passages); and meter-out oil passages F1 and F2 (oil-return passages). These oil passages D, E1, E2, F1, and F2 can change their orifice areas based on the stroke amount of the spool of the boom directional control valve 48. When the spool is in its neutral position, the center bypass oil passage D opens fully whereas the meter-in oil passages and the meter-out oil passages close completely. When the spool moves in the downward direction of FIG. 8 (in the boom-raising direction), the meter-in oil passage E1, designed to supply the pressurized oil from the hydraulic pump 29 to the bottom side of the hydraulic boom cylinder 20, and the meter-out oil passage F1, designed to return the oil from the rod side of the hydraulic boom cylinder 20 to the tank, increase in orifice area in response to the stroke amount of the spool. At the same time, the center bypass oil passage D decreases in orifice area; it closes completely at the maximum stroke position.

In contrast, when the spool moves in the upward direction of FIG. 8 (in the boom-lowering direction), the meter-in oil passage E2, designed to supply the pressurized oil from the hydraulic pump 29 to the rod side of the hydraulic boom cylinder 20, and the meter-out oil passage F2, designed to return the oil from the bottom side of the hydraulic boom cylinder 20 to the tank, increase in orifice area in response to the stroke amount of the spool. At the same time, the center bypass oil passage A decreases in orifice area. In this case, the orifice area of the center bypass oil passage D1 is, as illustrated in FIG. 9, approximately ten times as large as that of the meter-in oil passage E2 when the spool is in the middle position L3 of the boom-lowering spool stroke and also when it is in the maximum stroke position L4. Thus, the meter-in oil passage E2 is relatively small in flow rate.

When the lever 28 is moved backward (toward the left side of FIG. 8), the pressure reducing valve 34a generates a spool-control pilot pressure based on how much the lever 28 has been moved and then outputs the pressure to a pressure receiver 49a of the boom directional control valve 48 through the pilot line 35. This allows the spool of the boom directional control valve 48 to move from its neutral position to the lower side of FIG. 8 (i.e., in the boom-raising direction) in proportion to how much the lever 28 has been moved. In contrast, when the lever 28 is moved forward (toward the right side of FIG. 8), the pressure reducing valve 34b generates a spool-control pilot pressure based on how much the lever 28 has been moved and then outputs the pressure to a pilot circuit 50.

The pilot circuit 50 includes the following components: a pilot oil passage 51a for routing the spool-control pilot pressure generated by the pressure reducing valve 34b of the operating device 30 to the pressure receiver 36b of the boom directional control valve 31; a pilot oil passage 51b for routing the spool-control pilot pressure generated by the pressure reducing valve 34b of the operating device 30 to the pressure receiver 49b of the boom directional control valve 48; and a solenoid switch valve 52 for selecting either of the pilot oil passages 51a and 51b.

As in Embodiments 1 and 2, the hydraulic drive system of Embodiment 3 also includes the pressure sensor 41 and the controller 42. The pressure sensor 41 detects the rod-side pressure of the hydraulic boom cylinder 20. The controller 42 examines whether or not the rod-side pressure of the hydraulic boom cylinder 20 detected by the pressure sensor 41 is equal to or greater than the predetermined threshold value, thereby judging whether or not the hydraulic boom cylinder 20 needs driving pressure upon lowering the boom 17. Based on that judgment, the controller 42 controls the switch valve 52.

When the rod-side pressure is less than the threshold value (i.e., when driving pressure is not necessary), the controller 42 does not output a drive signal to the solenoid of the solenoid switch valve 52, placing the solenoid switch valve 52 in the right-side switch position of FIG. 8. This allows the spool-control pilot pressure generated by the pressure reducing valve 34b of the operating device 30 to be routed through the pilot oil passage 51b to the pressure receiver 49b of the boom directional control valve 48. As a result, the spool of the boom directional control valve 48 moves from its neutral position to the upper-side position of FIG. 8 (in the boom-lowering direction) in proportion to how much the lever 28 has been moved. Even if, in this case, the limit of the boom-lowering spool stroke of the boom directional control valve 48 is set to the maximum stroke position L4 by the operator moving the lever 28 furthest forward, the amount of oil supplied to the rod side of the hydraulic boom cylinder 20 becomes relatively small, keeping the rod-side pressure low. Accordingly, the own weight of the front arm structure 6 helps to drive the hydraulic boom cylinder 20, thereby reducing the power required of the hydraulic pump 29.

When, on the other hand, the rod-side pressure is equal to or greater than the threshold value (i.e., when driving pressure is necessary), the controller 42 outputs the drive signal to the solenoid of the solenoid switch valve 52, placing the solenoid switch valve 52 in the left-side switch position of FIG. 8. This allows the spool-control pilot pressure generated by the pressure reducing valve 34b of the operating device 30 to be routed through the pilot oil passage 51a to the pressure receiver 36b of the boom directional control valve 31. As a result, the spool of the boom directional control valve 31 moves from its neutral position to the upper-side position of FIG. 8 (in the boom-lowering direction) in proportion to how much the lever 28 has been moved. When, in this case, the limit of the boom-lowering spool stroke of the boom directional control valve 31 is set to the maximum stroke position L2 by the operator moving the lever 28 furthest forward, the amount of oil supplied to the rod side of the hydraulic boom cylinder 20 becomes relatively large, thus increasing the rod-side pressure. Accordingly, driving pressure is generated on the rod side of the hydraulic boom cylinder 20, thereby allowing a powerful boom descending motion.

Similar to Embodiments 1 and 2, Embodiment 3 of the invention also makes it possible to automatically change the operational characteristics of the boom directional control valves by judging whether or not the hydraulic boom cylinder 20 needs driving pressure at the time of lowering the boom 17. This is not bothersome to the operator and leads to high labor efficiency, compared with when the operator has to do the above with the use of a manual switch as in Patent Document 1.

As stated above, the hydraulic drive system of Embodiment 3 includes the solenoid switch valve 52 for selecting either of the pilot oil passages 51a and 51b, the pressure sensor 41 for detecting the rod-side pressure of the hydraulic boom cylinder 20, and the controller 42 for outputting the drive signal to the solenoid of the solenoid switch valve 52 when the rod-side pressure is equal to or greater than the threshold value. Note, however, that the invention is not limited to such an electrical configuration. For instance, the solenoid switch valve 52 can be replaced by a hydraulic pilot switch valve (not illustrated), and the pressure sensor 41 and the controller 42 by a hydraulic pilot control valve (not illustrated) for outputting a hydraulic pressure signal to a pressure receiver of that switch valve. The control valve can include a pressure receiver for receiving the rod-side pressure of the hydraulic boom cylinder 20 and a spring for setting a threshold value for the rod-side pressure. When the rod-side pressure is less than the threshold value, the control valve is placed in a first switch position, allowing the pressure receiver of the switch valve to communicate with the tank (that is, the hydraulic pressure received by the pressure receiver of the switch valve becomes the tank pressure, thus becoming smaller). As a result, the switch valve is placed in a first switch position to select the pilot oil passage 51b. When, on the other hand, the rod-side pressure is equal to or greater than the threshold value, the control valve is placed in a second switch position, allowing the pressure receiver of the switch valve to communicate with the pilot pump 26 (that is, the hydraulic pressure received by the pressure receiver of the switch valve becomes the pump pressure, thus becoming larger). As a result, the switch valve is placed in a second switch position to select the pilot oil passage 51a. The above modification also leads to the same advantages of Embodiment 3.

As another modification (not illustrated), it is also possible for the hydraulic drive system not to have the control valve and instead route the rod-side pressure of the hydraulic boom cylinder 20 to a pressure receiver of a switch valve and set a threshold value for the rod-side pressure using the spring of the switch valve. When the rod-side pressure is less than the threshold value, the switch valve is placed in a first switch position, thereby selecting the pilot oil passage 51b. When, on the other hand, the rod-side pressure is equal to or greater than the threshold value, the switch valve is placed in a second switch position, thereby selecting the pilot oil passage 51a. This modification also leads to the same advantages of Embodiment 3.

As also stated above, the hydraulic drive system of Embodiment 3 includes the pilot oil passages 51a and 51b and the solenoid switch valve 52 for selecting either of the pilot oil passages 51a and 51b as directional-control-valve selecting means for selecting either of the boom directional control valves 31 and 48. The invention is of course not limited to this configuration but can be modified in various forms without departing from the technical scope of the invention. For instance, when the invention is applied to a hydraulic excavator which includes an operating device having an electrical lever, a controller may be provided in order to select the destinations of the electrical control signal. This modification as well leads to the same advantages of Embodiment 3.

We have also stated that, in all the foregoing embodiments 1 to 3 and modifications, the center bypass oil passage of the boom directional control valve 31 is allowed to completely close when its spool is in the maximum position of a boom-raising stroke and to partially open when the spool is in the maximum position of a boom-lowering stroke. The invention is not limited to the above, however. The center bypass oil passage may instead close completely also when the spool is in the maximum position of a boom-lowering stroke. This also leads to the same advantages of the invention.

It should also be noted that the invention is not limited to the above-described examples in which the invention is applied to a small-sized hydraulic excavator.

The invention is of course applicable to medium- or large-sized hydraulic excavators and to other construction machines as well.

### DESCRIPTION OF REFERENCE NUMERALS

17: Boom
20: Hydraulic boom cylinder
28: Hydraulic pump
30: Operating device
31: Boom directional control valve
38a: Pilot oil passage (stroke limit varying means)
38b: Pilot oil passage (stroke limit varying means)
39: Pressure reducing valve (stroke limit varying means)
40: Solenoid switch valve (pilot-oil-passage selecting means, stroke limit varying means)
41: Pressure sensor (pressure judging means)
42: Controller (pressure judging means, control means)
43: Hydraulic pilot switch valve (pilot-oil-passage selecting means, stroke limit varying means)
43A: Hydraulic pilot switch valve (pilot-oil-passage selecting means, stroke limit varying means, pressure judging means, control means)
44: Control valve (pressure judging means, control means)
45: Pilot oil passage (stroke limit varying means)
46: Solenoid-driven variable pressure-reducing valve (stroke limit varying means)
47: Hydraulic pilot variable pressure-reducing valve (stroke limit varying means)
48: Boom directional control valve
51a: Pilot oil passage (directional-control-valve selecting means)
51b: Pilot oil passage (directional-control-valve selecting means)
52: Solenoid switch valve (pilot-oil-passage selecting means, directional-control-valve selecting means)

1. A hydraulic drive system for a construction machine, the system comprising: a hydraulic pump (28); a hydraulic boom cylinder (20) for actuating a boom (17); an operating device (30) for controlling the operation of the boom (17); and a boom directional control valve (31) for controlling the flow of pressurized oil routed from the hydraulic pump (28) to the hydraulic boom cylinder (20) in response to the operation of the operating device (30), the boom directional control valve (31) being an open center valve, the system having characteristics that allow the orifice area of a center bypass oil passage of the boom directional control valve (31) to become larger than the orifice area of a meter-in oil passage of the boom directional control valve (31) when a spool of the boom directional control valve (31) is in the middle position of a boom-lowering spool stroke and that allow the orifice area of the center bypass oil passage to become smaller than the orifice area of the meter-in oil passage or allow the center bypass oil passage to completely close when the spool is in the maximum stroke position of the boom-lowering spool stroke,
wherein the system further comprises:
stroke limit varying means (38a, 38b, 39, 40; 38a, 38b, 39, 43; 45, 46; 45, 47) for selecting either the middle position or the maximum stroke position as the limit of a boom-lowering spool stroke of the boom directional control valve (31);
pressure judging means (41, 42; 44) for detecting or receiving an oil-feeding-side pressure of the hydraulic boom cylinder (20) upon lowering the boom (17) and for judging whether or not the oil-feeding-side pressure is equal to or greater than a predetermined threshold value; and
control means (42; 44) for controlling the stroke limit varying means (40; 43; 46; 47) such that the limit of the boom-lowering spool stroke of the boom directional control valve (31) is set to the middle position when the oil-feeding-side pressure of the hydraulic boom cylinder (20) upon lowering the boom (17) is less than the threshold value and such that the limit of the boom-lowering spool stroke of the boom directional control valve (31) is set to the maximum stroke position when the oil-feeding-side pressure of the hydraulic boom cylinder (20) upon lowering the boom (17) is equal to or greater than the threshold value.

2. The hydraulic drive system of claim 1,
wherein the stroke limit varying means includes:
a first pilot oil passage (38a) for outputting a spool-control pilot pressure generated based on a boom-lowering operation by the operating device (30) to a pressure receiver of the boom directional control valve (31) without any change to the spool-control pilot pressure;
a second pilot oil passage (38b) for reducing, with the use of a pressure-reducing valve (39), a spool-control pilot pressure generated based on a boom-lowering operation by the operating device (30) and then outputting the reduced pressure to the pressure receiver of the boom directional control valve (31); and
pilot-oil-passage selecting means (40; 43) for selecting either the first pilot oil passage (38a) or the second pilot oil passage (38b) and
wherein the control means (42; 44) controls the pilot-oil-passage selecting means (40; 43) such that the second pilot oil passage (38b) is selected when the oil-feeding-side pressure of the hydraulic boom cylinder (20) upon lowering the boom (17) is less than the threshold value and such that the first pilot oil passage (38a) is selected when the oil-feeding-side pressure of the hydraulic boom cylinder (20) upon lowering the boom (17) is equal to or greater than the threshold value.

3. The hydraulic drive system of claim 1,
wherein the stroke limit varying means includes:
a pilot oil passage (45) for outputting a spool-control pilot pressure generated based on a boom-lowering operation by the operating device (30) to a pressure receiver of the boom directional control valve (31); and
a variable pressure-reducing valve (46; 47), located on the pilot oil passage (45), for limiting the maximum value of the spool-control pilot pressure in a variable manner and
wherein the control means (42; 44) controls a limit value set for the variable pressure-reducing valve (46; 47) such that the limit value becomes a predetermined first limit value when the oil-feeding-side pressure of the hydraulic boom cylinder (20) upon lowering the boom (17) is less than the threshold value and such that the limit value becomes a predetermined second limit value larger than the first limit value when the oil-feeding-side pressure of the hydraulic boom cylinder (20) upon lowering the boom (17) is equal to or greater than the threshold value.

4. A hydraulic drive system for a construction machine, the system comprising: a hydraulic pump (28); a hydraulic boom cylinder (20) for actuating a boom (17); an operating device (30) for controlling the operation of the boom (17); and a first boom directional control valve (31) for controlling the flow of pressurized oil routed from the hydraulic pump (28) to the hydraulic boom cylinder (20) in response to the operation of the operating device (30), the first boom directional control valve (31) being an open center valve, the system having characteristics that allow the orifice area of a center bypass oil passage of the first boom directional control valve (31) to become larger than the orifice area of a meter-in oil passage of the first boom directional control valve (31) when a spool of the first boom directional control valve (31) is in the middle position of a boom-lowering spool stroke and that allow the orifice area of the center bypass oil passage to become smaller than the orifice area of the meter-in oil passage or allow the center bypass oil passage to completely close when the spool is in the maximum stroke position of the boom-lowering spool stroke,
wherein the system further comprises:
a second boom directional control valve (48), the second boom directional control valve (48) being an open center valve, the orifice area of a center bypass oil passage of the second boom directional control valve (48) being larger than the orifice area of a meter-in oil passage of the second boom directional control valve (48) when a spool of the second boom directional control valve (48) is in the middle position and the maximum stroke position of a boom-lowering spool stroke;
directional-control-valve selecting means (51a, 51b, 52) for selecting either the first boom directional control valve (31) or the second boom directional control valve (48) and actuating the selected boom directional control valve in response to the operation of the operating device (30);
pressure judging means (41, 42) for detecting or receiving an oil-feeding-side pressure of the hydraulic boom cylinder (20) upon lowering the boom (17) and for judging whether or not the oil-feeding-side pressure is equal to or greater than a predetermined threshold value; and
control means (42) for controlling the directional-control-valve selecting means (52) such that the second boom directional control valve (48) is selected when the oil-feeding-side pressure of the hydraulic boom cylinder (20) upon lowering the boom (17) is less than the threshold value and such that the first boom directional control valve (31) is selected when the oil-feeding-side pressure of the hydraulic boom cylinder (20) upon lowering the boom (17) is equal to or greater than the threshold value.

5. The hydraulic drive system of claim 4,
wherein the directional-control-valve selecting means includes:
a first pilot oil passage (51a) for outputting a spool-control pilot pressure generated based on a boom-lowering operation by the operating device (30) to a pressure receiver of the first boom directional control valve (31);
a second pilot oil passage (51b) for outputting a spool-control pilot pressure generated based on a boom-lowering operation by the operating device (30) to a pressure receiver of the second boom directional control valve (48); and
pilot-oil-passage selecting means (52) for selecting either the first pilot oil passage (51a) or the second pilot oil passage (51b) and
wherein the control means (42) controls the pilot-oil-passage selecting means (52) such that the second pilot oil passage (51b) is selected when the oil-feeding-side pressure of the hydraulic boom cylinder (20) upon lowering the boom (17) is less than the threshold value and such that the first pilot oil passage (51a) is selected when the oil-feeding-side pressure of the hydraulic boom cylinder (20) upon lowering the boom (17) is equal to or greater than the threshold value.
